(19) United States
(12) Patent Application Publication
(10) Pub. No.: US 2008/0057314 A1
(43) Pub. Date: Mar. 6, 2008

(54) Low Heat Release and Low Smoke Reinforcing Fiber/Epoxy Composites

(75) Inventors: Sergei V. Levchik, Croton-on-Hudson, NY (US); Sophia Dashevsky, Monroe Township, NJ (US); Andrew M. Piotrowski, Yorktown, NY (US)

Correspondence Address: DILWORTH & BARRESE, LLP, 333 EARLE OVINGTON BLVD., SUITE 702, UNIONDALE, NY, 11553, US

(73) Assignee: SUPRESTA U.S. LLC., Ardsley, NY (US)

(21) Appl. No.: 11/547,107

(22) PCT Filed: Mar. 23, 2005
(86) PCT No.: PCT/US05/09634

§ 371 Date: Oct. 30, 2007

Related U.S. Application Data
(60) Provisional application No. 60/558,452, filed on Apr. 1, 2004.

(51) Int. Cl. C08K 3/32; C08G 59/00; C08K 5/53; C08L 63/00; C08J 5/04

(52) U.S. Cl. 428/413

(57) ABSTRACT

A composite material comprising reinforcing fiber and an adhesive composition comprising an epoxy resin, optionally a resin curing agent, a curing catalyst and a reactive phosphonate flame retardant and method of preparation thereof.

### CROSS REFERENCE TO RELATED APPLICATIONS

This application claims the benefit of Provisional U.S. Patent Application Ser. No. 60/558,452 filed Apr. 1, 2004, the entire contents of which are incorporated by reference herein.

### BACKGROUND OF THE INVENTION

The present invention relates to light-weight composite materials having high fire resistance and low smoke evolution, and is particularly concerned with structural composites formed from resin compositions, more particularly epoxy resin compositions, and reinforcing fibers. Such composites incorporate certain additives to substantially increase their fire resistance. They are particularly applicable as decorative, semi-structural, and structural components in aircraft.

Aviation industry concern has been directed to reducing the flammability and ignitability of composite materials used in the constructions of airline interior sidewalls, storage bins, ceilings, and partitions. From a fire safety viewpoint, sidewall panels are of particular concern because of their large surface area which may potentially be involved in a cabin fire.

The fiber composite materials used in the aviation industry generally include various adhesive epoxy compositions that have been used to impregnate a reinforcing system of fibers. The impregnated system of such reinforcing fibers exhibits good adhesion so that they may be easily attached to the core material of the composites. However, such epoxy resins, when exposed to flames, burn and produce smoke conditions that are undesirable for obvious safety reasons. In the case of non-flame retarded epoxy resins, the degradation of, for example, graphite/epoxy composites due to fire and the consequent break up of the graphite fibers and the spreading of these fibers to electrical equipment, can cause serious problems. Thus, any method that is developed to contain these short conductive fibers and prevent their spreading would be of great value.

Airline cabin fire hazards that impact survivability include: the flammability and heat release of the materials; smoke generation characteristics of such materials; and the resulting toxicity of the produced smoke. The relative importance of each of these hazards will depend on the circumstances surrounding any particular fire incident. For a post-crash cabin fire, a large fuel fire is the most predominant type of ignition source. It has been determined that “flash over”, which is the sudden and rapid uncontrolled growth of a fire from the area around the ignition source to the remainder of the cabin interior, has the greatest bearing on occupant survivability. Before the onset of flash over, the levels of heat, smoke and toxic gas are clearly tolerable; after the onset of flash over, the hazards increase rapidly to levels that make survival very unlikely. Thus, for an intense post-crash fire the most effective and direct means of minimizing the hazards resulting from burning cabin materials is to delay the onset of flash over. Flammability considerations, in contrast to smoke and toxicity considerations, directly affect the occurrence of flash over.

Therefore, the use of reinforcing fiber/resin composites depends not only on the strength of the composite due to the presence of the reinforcing fiber, but also on the fire resistance of the resin. There are many additives that, when incorporated into the resin, will act as fire retardants. Some, such as alumina trihydrate, ammonium polyphosphate, and zinc borate, are solids that offer excellent fire resistance, but they adversely affect the mechanical properties of the laminate, by causing an increase in laminate thickness with a consequent decrease in strength.

Some halogen-containing compounds can be used for these applications, and they are often combined with antimony trioxide as a synergist. The problem with these excellent flame retardant compounds is that they also have some highly objectionable properties. For example, aromatic bromine compounds are highly corrosive due to free bromine radicals and hydrogen bromide when they undergo thermal decomposition. Furthermore, the bromine does nothing to reduce the level of smoke that is produced when the resin burns. In fact, brominated epoxy resin may lead to increased levels of smoke production.

### BRIEF SUMMARY OF THE INVENTION

Accordingly, one object of the present invention is to provide reinforcing fiber/resin composites having high fire resistance and low smoke generation characteristics. Another object is to provide composites of the above type having the ability to withstand high temperature without splitting and spreading reinforcing fibers. A still further object is to provide adhesive epoxy resin compositions, and composites produced therefrom, containing a substance that substantially increases the fire resistance of the resin, without also adversely affecting the physical and mechanical properties of the composite, and that functions to stabilize the resin or resin char at high temperatures while maintaining the structural integrity of the composite.

Accordingly, the present invention provides a composite material comprising reinforcing fiber and an adhesive composition comprising an epoxy resin, optionally a resin curing agent, a curing catalyst and a reactive phosphonate flame retardant. A method of preparing the composite material is also provided herein comprising impregnating reinforcing fiber with the afore-described adhesive composition.

### DETAILED DESCRIPTION

Certain preferred embodiments of the invention will be described in detail in the following paragraphs.

The epoxy resin is present in the range from about 40 to about 80 wt. % of the total weight of the adhesive formulation. Representative resins include: bisphenol A type epoxy resin; bisphenol F type epoxy resin; bisphenol S type epoxy resin; 4,4′-biphenol type epoxy resin; phenol novolac type epoxy resin; cresol novolac type epoxy resin, bisphenol A novolac type epoxy resin; bisphenol F novolac type epoxy resin; phenol salicylate aldehyde novolac type epoxy resin; alicyclic epoxy resin; aliphatic chain epoxy resin; glycidyl ether type epoxy resin; and other compounds such as a bi-functional phenol group glycidyl ether compound; bi-functional alcohol glycidyl ether compound; polyphenol group glycidyl ether compound; and polyphenol glycidyl ether compound and its hydride. Mixtures of such resins may also be employed.

The reactive phosphonate flame retardant composition that forms a novel and essential additive herein, as compared to prior art approaches that relied upon varying combinations of the previously described components, is present at from about 5% to about 60 wt. % of the total weight of the adhesive formulation, preferably from about 10 to about 30 wt. %. This flame retardant, which is described in PCT International Patent Publication No. WO 03/029258 and PCT International Publication No. WO/2004/113411, (the entire contents of which are incorporated by reference herein) is an oligomeric phosphonate comprising the repeating unit (—OP(O)(R)—O-Arylene-)ₙ wherein “n” can range from about 2 to about 30 and has a phosphorus content of greater than about 12%, by weight. The R group can be lower alkyl, such as C₁-C₆. Preferably, R is methyl. These oligomeric phosphonates useful in the practice of the present invention may or may not contain —OH end groups. The individual phosphonate species that contain —OH end groups can be monohydroxy or dihydroxy-substituted. The end groups can be attached to the arylene moiety or to the phosphorus moiety, and they are reactive with the epoxy functionality in the composition to which the flame retardant is added. The concentration of —OH end groups attached to phosphorus will range from about 20% to about 100%, based upon the total number of termination ends (“chain ends”) that potentially could hold such end groups, preferably from about 50% to about 100%.

By “Arylene” is meant any radical of a dihydric phenol that should have its two hydroxy groups in non-adjacent positions. Examples of such dihydric phenols include the resorcinols; hydroquinones; and bisphenols, such as bisphenol A, bisphenol F, and 4,4′-biphenol, phenolphthalein, 4,4′-thiodiphenol, or 4,4′-sulfonyldiphenol. A small amount of polyhydric phenol, such as a novolac or phloroglucinol, with three or more hydroxyl groups therein can be included to increase the molecular weight of the composition. The “Arylene” group can be 1,3-phenylene, 1,4-phenylene, or a bisphenol diradical unit, but it is preferably 1,3-phenylene.

This component for the epoxy resin composition of the present invention can be made by any of several routes: (1) the reaction of a compound of the formula RPOCl₂ with HO-Aryl-OH, or a salt thereof, where R is lower alkyl, preferably methyl; (2) the reaction of diphenyl alkylphosphonate, preferably methylphosphonate, with HO-Arylene-OH under transesterification conditions; (3) the reaction of an oligomeric phosphite with repeating units of the structure —OP(OR′)—O-Arylene- with an Arbuzov rearrangement catalyst, where R′ is lower alkyl, preferably methyl; or (4) the reaction of an oligomeric phosphite with the repeating units having the structure —OP(O-Ph)-O-Arylene with trimethyl phosphite and an Arbuzov catalyst or with dimethyl methylphosphonate with, optionally, an Arbuzov catalyst. The —OH end groups, if attached to Arylene can be produced by having a controlled molar excess of the HO-Arylene-OH in the reaction media. The —OH end groups, if an acid type (P—OH), can be formed by hydrolytic reactions. It is preferred that the end groups of the oligomers be mainly -Arylene-OH types. The molecular of the phosphonate oligomers can be controlled, for example, by adjusting the ratio between the starting reagents, e.g. diphenyl methylphosphonate and resorcinol (reaction scheme (2) hereinabove). The highest molecular weight is obtained with the molar ratio close to 1:1. An excess of any of these reagents leads to lower molecular weights. The molecular weight may also be controlled by adjusting the reaction times. Larger reaction times yield higher molecular weight product.

Optionally, a curing agent, such as a multifunctional phenol may be included in the adhesive formulation in amounts, for example, in the range from about 5% to about 10 wt. % of the total weight of the adhesive formulation. Such curing agents include, for example, a bisphenol F; bisphenol A; bisphenol S; polyvinyl phenol; and a novolac resin, which is obtained by addition condensation of a phenol group such as phenol, cresol, alkylphenol, catechol, bisphenol F, bisphenol A and bisphenol S with an aldehyde group. The molecular weight of any of these compounds is not particularly limited, and mixtures of such materials may be employed.

A curing catalyst is used in the adhesive formulation in amounts ranging from about 0.05 to about 1.0 wt. % of the total weight of the adhesive formulation and may be any compound that functions to accelerate the chemical reaction of the epoxy group with a phenol hydrate group. Representative catalysts include the alkaline metal compounds, alkaline earth metal compounds, imidazole compounds, organic phosphorus compounds, secondary amines, tertiary amines, tetraammonium salts and the like.

The imidazole compounds that may be used with the present invention include imidazole, 2-ethylimidazole, 2-ethyl-4-methylimidazole, 2-phenylimidazole, 2-undecylimidazole, 1-benzyl-2-methylimidazole, 2-heptadecyl imidazole, 4,5-diphenylimidazole, 2-methylimidazoline, 2-phenylimidazoline, 2-undecylimidazoline, 2-heptadecylimidazoline, 2-isopropylimidazole, 2,4-dimethyl imidazole, 2-phenyl-4-methylimidazole, 2-ethylimidazoline, 2-isopropylimidazoline, 2,4-dimethylimidazoline, 2-phenyl-4-methylimidazoline and the like. These curing catalysts may be used in combination with one another.

Generally, in the practice of the present invention, the adhesive formulation comprises from about 20 to about 60%, by weight of the total weight of the composite material.

Reinforcing fibers useful in the practice of the present invention include, for example, graphite fibers, glass fibers and other mineral fibers, such as wollastonite. Composites fabricated from graphite fibers are preferred therein. Graphite fibers can be described as those carbon fibers obtainable from the processing of mesophase or non-mesophase petroleum pitch, carbon fibers, or from coal tar pitch or similar carbon-containing materials. Furthermore, carbon fibers made using PAN, acrylic, or rayon precursors may also be used. The carbon fiber forms useful in this invention consist of paper, felt, or mat (woven or non-woven) structures.

Generally, in the practice of the present invention, the reinforcing fibers comprise from about 50% to about 90% by weight of the total weight of the composite material.

In a preferred embodiment of the present invention, graphite fiber mat is generally impregnated with a solution of the epoxy resin adhesive formulation, as described above, using a solvent for the resin, such as acetone or methylethyl ketone. Impregnation techniques include dipping, brushing, spraying, and the like. The thus-impregnated mat is allowed to dry thereby forming a prepreg (containing about 20% to about 40% by weight content of adhesive) which can then be cured by either vacuum bagging in an autoclave or by hot press curing at from about 150° to about 225° C. for about one to about two hours to produce a laminate which is suitable for commercial aircraft interior.

This invention is further illustrated in the following representative Examples.

### EXAMPLE 1

Phenol-formaldehyde resin (HRJ 2210 brand from Schenectady International), 11 grams, was dissolved in 30 ml of 2-butanone solvent at 60° C., and 63.5 g of epoxy novolac resin (RUETAPOX 300 brand from Bakelite AG) and 25 g of reactive poly(m-phenylene methylphosphonate) wherein “n” is about 14 (synthesized as described hereinbelow) were then added so that they also dissolved at 60° C. into the solvent. Then, 0.5 wt % of 2-methyl imidazole (AMI-2 brand from Air Products) was added. The resultant warm varnish was applied to a plain weave graphite fabric (No. 530, from Fibre Glast). The resulting prepreg was dried at room temperature overnight and then at 90° C. for thirty minutes. Then, sixteen piles of the prepreg (4×4 inches) were stacked together, were pre-cured for thirty minutes at 130° C. and 8 MPa pressure, and were then cured for seventy minutes at 171° C. and 30 MPa pressure.

### Preparation of Poly(m-phenylene methylphosphonate)

124 g (0.5 mol) of diphenyl methyl-phosphonate, 113 g (1.03 mol) of resorcinol and 0.54 g of sodium methylate were heated and stirred in a reaction flask at 230° C. The reaction flask was provided with an about 40 cm-high Vigreux column wrapped with electrical heating tape and insulation to keep the phenol and any volatilized resorcinol from solidifying in the column. Vacuum was gradually dropped from 625 mm to 5 mm Hg. The reaction stopped after four hours. Phenol was distilled off during reaction, and 93 g of distillate (about 1 mol if calculated as phenol) was collected in the cold trap with 241 g (poly(m-phenylene methylphosphonate) product remaining in the reaction flask. The distillate appeared to be almost pure phenol.

### (COMPARATIVE) EXAMPLE 2

In this Example, 15 g of phenol-formaldehyde resin (HRJ 2210 brand from Schenectady International) was dissolved in 30 ml of 2-butanone at 60° C., and then 84.5 g of epoxy novolac resin (RUETAPOX 300 brand from Bakelite AG) was added so that it also dissolved at 60° C. in the solvent. Then, 0.5 wt % of 2-methyl imidazole (AMI-2 brand from Air Products) was added. Further manufacturing of prepreg and composite was analogous to that described in Example 1.

### (COMPARATIVE) EXAMPLE 3

In this Example, 15 g of phenol-formaldehyde resin (HRJ 2210 brand from Schenectady International) was dissolved at 60° C. in 100 g of acetone solution containing 84.5 g of brominated bisphenol A epoxy resin (D.E.R. 530-A80 brand from Dow Chemicals). Then, 0.5 wt % of 2-methyl imidazole (AMI-2 brand from Air Products) was added. Further manufacturing of prepreg and composite was analogous to the description in Example 1.

### EXAMPLE 4

The flammability of the composites manufactured in each of Examples 1 to 3 was then evaluated with a Cone Calorimeter at a heat flux of 75 kw/m² according to the ISO/DP 5660 standard. The results of such flammability testing is provided in the following Table:

| Parameter | Ex. 1 | Ex. 2 | Ex. 3 |
|---|---|---|---|
| Time to ignition (sec.) | 44 | 13 | 18 |
| Mass loss (wt. %) | 37 | 43 | 49 |
| Average heat release rate (kW/m²) | 73 | 110 | 85 |
| Total heat evolved (MJ/m²) | 60 | 81 | 59 |
| Total smoke released (arb. Units) | 2750 | 3220 | 5180 |

The foregoing examples merely illustrate certain embodiments of the present invention and, for that reason should not be construed in a limiting sense. The scope of protection that is sought is set forth in the claims that follow.

We claim:

1. A composite material comprising reinforcing fiber and an adhesive composition comprising an epoxy resin; optionally, a resin curing agent, a curing catalyst and a reactive phosphonate flame retardant.

2. The composite material of claim 1 wherein the reinforcing fiber comprises from about 50% to about 90%, by weight of the total weight of the composite.

3. The composite material of claim 1 wherein the adhesive composition comprises from about 20% to about 60%, by weight of the total weight of the composite.

4. The composite material of claim 1 wherein the epoxy resin comprises from about 40% to about 80%, by weight of the total weight of the adhesive composition.

5. The composite material of claim 1 wherein the reactive phosphonate flame retardant comprises from 5% to 60%, by weight of the total weight of the adhesive composition.

6. The composite material of claim 1 wherein the curing catalyst is present from 0.05% to 1.0% by weight of the total weight of the adhesive composition.

7. The composite material of claim 1 wherein the optional resin curing agent comprises from 5% to about 10%, by weight of the total weight of the adhesive composition.

8. The composite material of claim 1 wherein the reinforcing fiber is selected from the group consisting of graphite, glass and wollastonite.

9. The composite material of claim 1 wherein the reactive phosphonate flame retardant is an oligomeric phosphonate comprising the repeating unit (—OP(O)(R)—O-Arylene-)ₙ wherein “n” is from about 2 to about 30.

10. The composite material of claim 8 wherein the reinforcing fiber is graphite.

11. The composite material of claim 9 wherein the reactive phosphonate flame retardant is poly(m-phenylene methylphosphonate).

12. A method of preparing a composite material, said method comprising impregnating reinforcing fiber with an adhesive composition comprising an epoxy resin, optionally, a resin curing agent, a curing catalyst and a reactive phosphonate flame retardant.

13. The method of claim 12 wherein the reinforcing fiber is selected from the group consisting of graphite, glass and wollastonite.

14. The method of claim 12 wherein the reactive phosphonate flame retardant is an oligomeric phosphonate comprising the repeating unit (—OP(O)(R)—O-Arylene-)ₙ wherein “n” is from about 2 to about 30.

15. The method of claim 14 wherein the reactive phosphonate flame retardant is poly(m-phenylene methylphosphonate).
